(19) United States
(12) Patent Application Publication
(10) Pub. No.: US 2023/0102376 A1
(43) Pub. Date: Mar. 30, 2023

(54) Spring Operated Gear Track System Accessory Attachment Device

(71) Applicant: Bram Owen Olson, Waldorf, MN (US)

(72) Inventor: Bram Owen Olson, Waldorf, MN (US)

(21) Appl. No.: 17/477,656

(22) Filed: Sep. 17, 2021

(51) Int. Cl. F16M 13/02

(52) U.S. Cl. CPC F16M 13/02

(57) ABSTRACT

The invention features the new system of spring compression to provide the force necessary to securely attach accessories to gear track systems. The invention also features a customized bolt design allowing the bolt to be inserted into the gear track system from near perpendicularly above, turned (rotated) such that the bolt flanges catch on the underside of the gear track flanges, and held into place via the compression spring(s). This allows the attachment/detachment of gear track accessories to take a significantly less amount of time versus the old method.

### CROSS-REFERENCE TO RELATED APPLICATIONS

Provisional Patent submitted May 23, 2020

Email received Jun. 23, 2020 EFS-Web Receipt for 63043061

### STATEMENT REGARDING FEDERALLY SPONSORED RESEARCH OR DEVELOPMENT (IF APPLICABLE)

Not Applicable

### REFERENCE TO SEQUENCE LISTING, A TABLE, OR A COMPUTER PROGRAM LISTING COMPACT DISC APPENDIX (IF APPLICABLE)

Not Applicable

### BACKGROUND OF THE INVENTION

I purchased a used kayak, specifically a Nucanoe Frontier 12, in the spring of 2019. The sit-on-top kayak features an “open-deck” style, with a set of rails, or gear tracks that run along the sides of the open deck, another set back towards the transom, and a third up near the bow. These rails, or gear tracks, are used to attach accessories to the vessel. At this time, the only way to accomplish this was to slide a threaded bolt with an attached flange in from the open end of the rail, or gear track. It was not possible to simply insert the bolt/flange from the top gap in the gear track. After sliding the bolt (with connected flange) in from the end of the track, one would have to move it to the desired position, and repeat this process if additional bolts were needed to secure the accessory of interest. For example, a seat base has 4 anchor points. I would have to slide 2 bolts in on each side, move them to desired position, then put the seat base on by inserting the threaded bolts through a hole or slot in the seat base. After the seat base was on, and the threaded bolts (held in by the track) were sticking up through the holes or slots in the seat base, then I would thread on a plastic threaded knob. This process required sliding the bolts with flange in from the end of the track, lining them up with the accessory/base holes/slots, then manually tightening up the knob, to secure the accessory to the kayak gear track.

I wanted to invent a system that didn’t require sliding the bolts in from the end of the track, but rather be able to attach accessories to the gear track system quickly and securely from directly above. So in June of 2019 I had an idea. I would design a new style of T-bolt that had a flange along one axis only, allowing the “T” part of the threaded bolt to fit into the gear track from the top, then, on top of the accessory/base, use a compression spring to provide the strength to secure the accessory. The threaded bolt would still feature a threaded knob, which would compress the spring, hence holding the accessory in place. So, the newly designed “T-Bolt” would fit down into the open slot on top of the gear track. I would push down and turn it 90 degrees so that the single-axis flange would then catch under the gear track top flanges (sides). The compression spring would then push against the threaded knob, and pull the new T-bolt up. This compression would hold the accessory to the gear track.

Time to make a prototype. I found various T-bolts, toilet bowl bolts and regular bolts to modify to make this happen. I also experimented with several springs, varying in length and strength. Using threaded knobs from the hardware store, I was able to make a few crude prototypes to suffice.

After that, it was time to refine the design. I then researched custom springs and experimented with several dozen. I experimented with various bolt lengths, everything being threaded ¼-20. I finally settled on two bolt lengths, and had 4 spring options.

To keep the spring centered all the time, I designed custom “spring retainers”, or shoulder washers, to fit inside the spring at each end. This kept the spring centered during compression and use.

I used stainless steel for the bolts. I chose stainless steel springs for the springs. The spring retainers are made of PET (PET-P), currently black in color. These materials are safe for fresh and saltwater. I added off the shelf 1” stainless steel washers to keep the device onto the accessory/base (otherwise, if slotted, it would simply come out/off) and for a more aesthetic appeal. The idea was to keep the device onto the accessory/base at all times. This simplified the process of attaching the accessory/base to the gear tracks, saving a lot of time and effort. Detaching requires a simple twist of the device 90 degrees so the newly designed T-bolt flange pops out from the gear track via the spring compression.

### BRIEF SUMMARY OF THE INVENTION

When it comes to attaching and detaching accessories to gear track systems in kayaks, canoes, ATV’s or otherwise, the most commonly used method is to utilize a multi-dimensionally (multi-axis) flanged, threaded T-bolt, in conjunction with a threaded knob. This would require sliding the T-bolt into the gear track, or as of recently, dropping the T-bolt into the track at an angle. Both methods require manual turning of the threaded knob to securely attach the accessory to the gear track. The invention at hand eliminates nearly all the time it takes to securely attach accessories to gear track systems using spring compression. A compression spring is used with a custom-designed T-bolt that is pushed down from the top of the gear track, turned 90 degrees, and the single-axis flange will “catch” onto the gear track flange. The spring compression pushes against the gear track and the threaded knob to provide the force necessary to securely attach accessories to gear track systems. To detach, simply turn the device 90 degrees and the spring compression will pull the custom single-axis-flanged T-bolt up and the accessory attachment point will then be completely detached. To keep the spring centered, there are shoulder washers (spring-retainers) that are custom-designed to fit the specific spring. This provides a consistently-centered spring for consistent, centered compression.

### BRIEF DESCRIPTION OF THE SEVERAL VIEWS OF THE DRAWINGS

Drawing 1 consists of FIG. 1 and FIG. 2.

FIG. 1 is the Front View of the invention.

FIG. 2 is the Side View of the invention.

Drawing 2 consists of FIG. 3, FIG. 4, FIG. 5 and FIG. 6.

FIG. 3 is the side view of the design for the 3” bolt.

FIG. 4 is the top view of the design for the 3” bolt.

FIG. 5 is the side view of the design for the 2 ¼” bolt.

FIG. 6 is the top view of the design for the 2 ¼” bolt.

Drawing 3 consists of FIG. 7, FIG. 8, FIG. 9 and FIG. 10.

FIG. 7 is the side view drawing of the custom designed shoulder washer (spring retainer) to fit spring models 72101S and 72104S found on www.CenturySprings.com.

FIG. 8 is the top view drawing of the custom designed shoulder washer (spring retainer) to fit spring models 72101S and 72104S found on www.CenturySprings.com.

FIG. 9 is the side view drawing of the custom designed shoulder washer (spring retainer) to fit spring models 72114S and 72117S found on www.CenturySprings.com.

FIG. 10 is the top view drawing of the custom designed shoulder washer (spring retainer) to fit spring models 72114S and 72117S found on www.CenturySprings.com.

Drawing 4 consists of FIG. 11, FIG. 12 and FIG. 13.

FIG. 11 is the side view and top view of the stainless steel washers used for the invention, which are “off the shelf” and acquired from Amazon.com. For future models of the invention on the market, the washer dimensions are subject to change.

FIG. 12 is a side view of a threaded knob that is threaded onto FIG. 3, FIG. 4, FIG. 5, or FIG. 6. It is ¼-20 threaded and depth is ½”. Exact knob design and dimensions vary as there are many options available to use for the invention. These were acquired from McMaster-Carr.

FIG. 13 is a side view of a compression spring used for the invention. It is a stainless-steel compression spring and provides the force necessary to adequately attach to the gear track system. The actual springs used for the various models of the invention will vary, but for the invention, spring models 72114S, 72117S, 72101S and 72104S were used. These were found at CenturySprings.com. Future models of the invention on the market will feature different spring(s), but the use of spring force is mentioned as one of the claims of the invention.

### DETAILED DESCRIPTION OF THE INVENTION

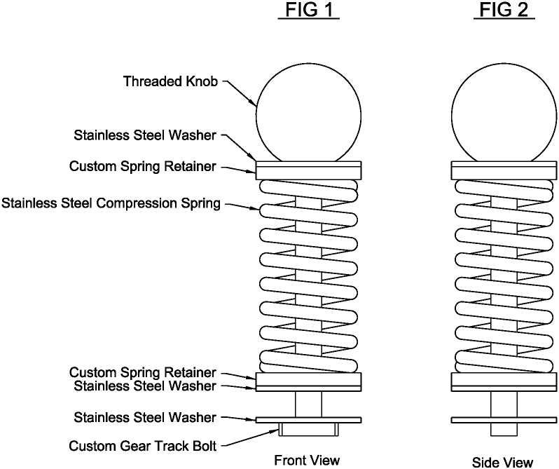

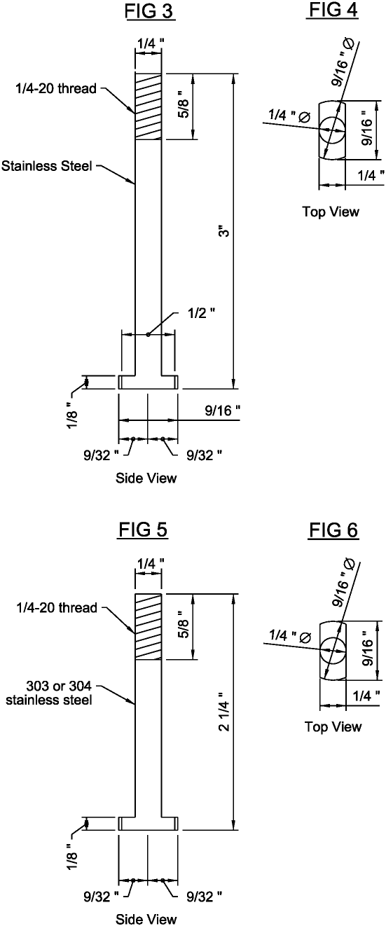

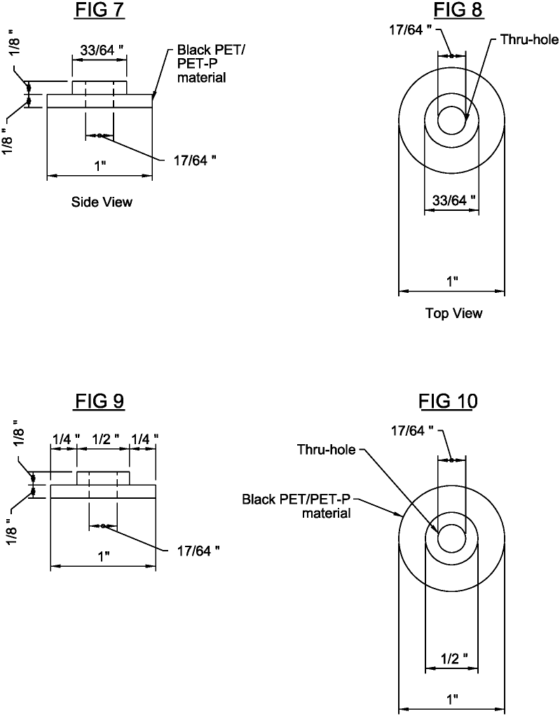

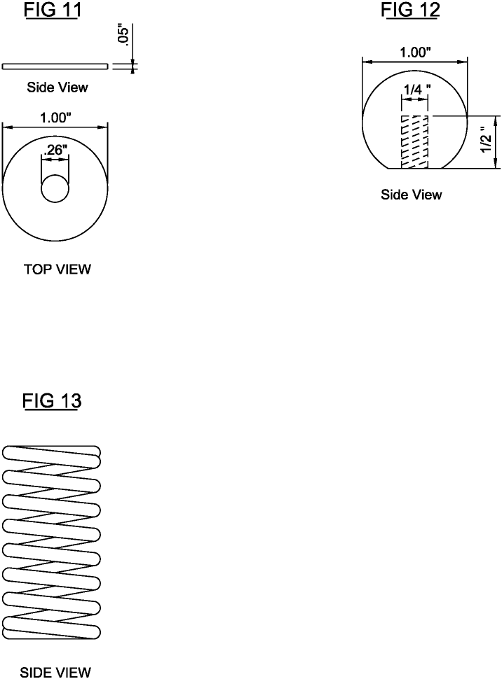

The invention is comprised of a threaded knob (see FIG. 1), stainless steel washers (FIG. 11), stainless steel compression spring (FIG. 13), custom-designed to fit quality thermoplastic polyester shoulder washers or “spring retainers” (FIG. 7/FIG. 8 and FIG. 9/FIG. 10), and a custom designed-to-fit stainless steel “T-bolt” (FIG. 3/FIG. 4 and FIG. 5/FIG. 6).

To create the device/invention, first choose what size single-axis-flanged T-bolt you want and compression spring choice. The 3” bolt accommodates spring models 72117S and 72104S. The 2.25” bolt accommodates spring models 72101S and 72114S. See FIGS. 3 / 4 and FIGS. 5 / 6. This will determine what length compression spring you want (they vary in force, i.e. lbs/inch, and also vary in inside diameter). For example, let’s say you choose FIG. 3/ FIG. 4. This is the 3” bolt model. Also, for example, choose spring model 72117S.

To create the bolt, start off with a 9/16” stainless steel rod, made of SS303 or SS304. Between CNC machining and a lathe, manipulate the stainless-steel rod to match the dimensions and specifications illustrated by the schematic diagram shown in FIG. 3 and FIG. 4.

For the shoulder washers (spring retainers), see FIG. 9 and FIG. 10. This spring retainer is specifically designed to fit perfectly inside compression spring models 72117S and 72114S. FIG. 7 and FIG. 8 are designed for compression spring models 72101S and 72104S. To create FIGS. 9/10, start out with a 1” diameter rod made of PET/PET-P in the color of your liking, in this case, black. This is a high-quality thermoplastic polyester.

Using a lathe and/or CNC machining, create the spring retainers to match the schematics/dimensions depicted in FIG. 9/ FIG. 10.

For the knob, go to McMaster-Carr or other retailers and look for a threaded knob that has a thread depth of ½ʺ - ⅝ʺ, because the bolt thread length is ⅝ʺ. The thread of the knob should be ¼-20. There are several options available.

For the spring, purchase compression spring model 72117S from Century Springs. See FIG. 13.

For the stainless-steel washers, go to Amazon.com and purchase the 1” diameter, stainless steel washers. The inside hole diameter is 0.26ʺ and the washers are 0.05ʺ in thickness. See FIG. 11.

Once all components are acquired (See FIG. 1 and FIG. 2), start assembly by first sliding one stainless steel washer onto the bolt. Then, slide the bolt up through the bottom of the accessory/base. Then, slide another stainless-steel washer onto the bolt, this will rest on the accessory/base. Then slide one of the spring retainers onto the bolt, with the smaller-diameter side up. Then slide the spring onto the spring retainer. Then slide the other spring retainer onto the bolt with the smaller diameter side down. This will fit into the spring. Then slide the last stainless-steel washer onto the bolt. Then thread the knob onto the bolt enough to meet your desired amount of force/compression.

I recommend using thread-lock in the knob threads before threading the knob onto the bolt in order to keep the knob into position throughout use.

The invention/device should be installed onto the accessory/base such that when the accessory/base is set onto the gear tracks, the invention/device is lined up with the gear track top gaps. At this point, simply line up, by turning, the invention/device bolt (via the knob) so it will fit inside the gear track top gap. From there, simply push down on the device’s knob to compress the spring enough such to allow a 90 degree twist of the device. Once the single-axis flange of the bolt is turned 90 degrees, simply let pressure off of the knob, allowing the compression spring to “push” against the spring retainers, in turn, pushing against the threaded knob, hence “pulling” the bolt up such that the flange of the bolt will “catch” the underside of the gear track flanges. This in turn will compress the accessory/base down onto the gear tracks, hence attaching the accessory/base to the gear tracks.

To detach the accessory/base from the gear tracks, once attached, simply turn the threaded knob of the device/invention until the single-axis bolt flange “pops” out from the underside of the gear track flanges. Once all devices/inventions are free from the underside of the gear track flanges, simply lift the accessory/base up off the gear tracks.

The old system utilizes T-bolts that cannot fit from directly above the gear track system. Depending on the gear track top “flanges”, the old T bolts had to be slid in from the end of the gear track, or could be set in from the wider top gap in the gear track, but only at an extreme enough angle. The invention doesn’t require either of these approaches. The design of the invention’s T-bolt allows the bolt to be inserted into the gear track from directly above. The invention can be used as a stand-alone anchor point or installed on accessories/bases to secure the accessory/base to the gear tracks.

The invention utilizes the power of spring compression to provide the force necessary to secure/attach accessories to the gear tracks. The only spinning required comes after the device’s T-bolt flange-axis is lined up in the gear track gap, the spring is compressed enough to allow the T-bolt flange to be rotated 90 degrees. Once that is done, the force compressing the spring can be relieved, and the compression spring will pull the T-bolt flange up to catch the underside of the gear track flanges, hence securing the accessory/base to the gear tracks.

The old method, regardless of gear track design, requires the manual spinning of the threaded knob enough to be completely removed. At that point, the accessory/base can be pulled up off the T-bolts, then the bolts themselves can be removed from the end of the track, or angled enough to slip out from the top. The invention saves time and effort required to attach/detach accessories/bases to the gear track systems.

1. The use of spring compression (regardless of compression spring type) to provide the force necessary to attach and detach accessories to gear track systems.

2. The design of the bolt used for attachment devices for the accessories for gear track systems that allows the bolt flanges to be lined up with the top gap of the gear track system, will fit between the gear track flanges enough for the flanges of the bolt to clear the underside of the gear track flanges and be rotated such that the bolt flanges catch on the underside of the gear track flanges.

3. The use of custom-designed shoulder washers to retain the position of the spring upon compression and use.
